(19) United States
(12) Patent Application Publication
(10) Pub. No.: US 2013/0225221 A1
(43) Pub. Date: Aug. 29, 2013

(54) Method and Apparatus for Transfer of Radio Resource Allocation

(71) Applicant: Markus Nentwig, Helsinki (FI)

(72) Inventor: Markus Nentwig, Helsinki (FI)

(73) Assignee: NOKIA CORPORATION, Espoo (FI)

(21) Appl. No.: 13/641,955

(22) PCT Filed: Apr. 23, 2010
(86) PCT No.: PCT/IB2010/000946

§ 371 Date: May 1, 2013

(51) Int. Cl. H04W 72/04

(52) U.S. Cl. CPC H04W 72/04
USPC 455/510

(57) ABSTRACT

In accordance with an example embodiment of the present invention, an apparatus comprising a transmitter configured to transmit a message releasing radio resource, a receiver configured to receive one or more requests for acquisition of at least part of the released radio resource and a controller configured to defer grant of any request for radio resource acquisition if more than a predetermined number of requests is received within a predetermined time window.

### TECHNICAL FIELD

The present application relates generally to transfer of radio resource allocation.

### BACKGROUND

A popular technique for addressing increasing demand on capacity of radio networks is to reduce cell sizes. A direct implication of smaller cell sizes is large number of access points in the network. This makes conventional network planning impractical due to difficulty in modeling the environment with the level of detail needed for small cells. Hence, radio systems must manage resources by directly negotiating the use of radio spectrum amongst themselves. This holds true for operation in operator controlled licensed bands, operation in unlicensed bands, and possible combinations that arise when cellular operators decide to operate in no-cost unlicensed spectrum.

Direct negotiation between radio nodes for spectrum sharing is a rather challenging problem because conventional control links between competing nodes do not exist and cannot be easily established. Instead, signaling is handled using low-level messages that are detected from the baseband I-Q data stream, which are asynchronous with data transmission and reception.

A well known mechanism for radio resource management is the RTS/CTS mechanism. Under this mechanism, a first node wishing to reserve channel resources sends a Request To Send (RTS) message to another node. The another node responds with Clear To Send (CTS) frame informing the first node that the wireless channel resources have been reserved for it. A third node that overhears an RTS or CTS packet inhibits its transmitter for a specified time. This helps reduce the probability of a collision with a subsequent CTS or data packet.

An improvement to the RTS/CTS scheme is the MACA protocol which is particularly advantageous in the hidden node scenario and the exposed node scenario. In the classic hidden node scenario, a station Y can hear both stations X and Z, but X and Z cannot hear each other. X and Z are therefore unable to avoid colliding with each other at Y. In the exposed node scenario, a well-situated station X can hear far away station Y even though X is too far from Y to interfere with its traffic to other nearby stations. X will defer to Y unnecessarily, thus wasting an opportunity to reuse the channel locally. Sometimes there can be so much traffic in the remote area that the well-situated station seldom transmits. MACA protocol solves this problem, at least in part, by including in the RTS packet, the amount of data a node plans to send and by echoing this information in its CTS packet. This piece of information in the RTS and CTS packets informs a third node that receives a RTS or a CTS packet, how long it must wait before transmitting its own packet.

A multi-stage contention scheme divides the nodes contending for system resources into smaller groups to resolve the contention more efficiently. For example in a two-stage contention scheme, nodes contending for resources first randomly select backoff counters in the range of (0, W₁−1). The nodes listen to the channel as long as their backoff counters do not expire. When the backoff counter of a node expires, the node transmits a specific signal detectable by other nodes. Nodes that transmit this signal are the winners of the first stage and continue contention for resources in the second stage. The stations that hear this signal must wait for the next transmission round. The winners of the first stage select new backoff counters in the range of (0, W₂−1), and they transmit their frames when these counters expire. Collisions can still happen in the second stage. However, since the number of contending stations is much smaller in the second stage, the chance to have one winner is higher. This scheme can easily be extended to more than two stages.

In other techniques for radio resource management, contender nodes are eliminated by referee nodes.

### SUMMARY

Various aspects of examples of the invention are set out in the claims.

According to a first aspect of the present invention, an apparatus, comprising a transmitter configured to transmit a message releasing radio resource, a receiver configured to receive one or more requests for acquisition of at least part of the released radio resource and a controller configured to defer grant of any request for radio resource acquisition if more than a predetermined number of requests is received within a predetermined time window.

According to a second aspect of the present invention, a method, comprising releasing a radio resource by a network node, starting a time window wherein to receive one or more requests for acquisition of at least part of the released radio resource and deferring grant of any request for acquisition if more than a predetermined number of requests is received within the time window.

According to a third aspect of the present invention, a computer program, comprising code for transmitting a message indicating released radio resource, code for starting a time window wherein to receive, from one or more of other network nodes, requests for acquisition of at least part of the released radio resource and code for deferring grant of any request for acquisition if more than a predetermined number of requests is received within the time window, when the computer program is run on a processor.

### BRIEF DESCRIPTION OF THE DRAWINGS

For a more complete understanding of example embodiments of the present invention, reference is now made to the following descriptions taken in connection with the accompanying drawings in which:

FIG. 1 shows wireless nodes in a radio environment;

FIG. 2a shows a first example of structuring wireless medium into radio resources;

FIG. 2b shows a second example of structuring wireless medium into radio resources;

FIG. 2c shows a third example of structuring wireless medium into radio resources;

FIG. 3 shows in-phase and quadrature components of a message waveform S1(t);

FIG. 4 shows output of a matched filter matched to signal S1(t), for two different input signals S1(t) and S2(t);

FIG. 5 shows an apparatus according to an embodiment of the invention;

FIG. 6 shows signaling between network nodes in order to transfer radio resource according to an example embodiment of the invention;

FIG. 7 shows a flowchart for operation of a node releasing radio resource according to an example embodiment of the invention;

FIG. 8 shows signaling between network nodes in order to transfer radio resource using subgroup message according to another example embodiment of the invention; and

FIG. 9 shows a flowchart of a method implemented at a node competing for radio resource according to an example embodiment of the invention.

### DETAILED DESCRIPTION OF THE DRAWINGS

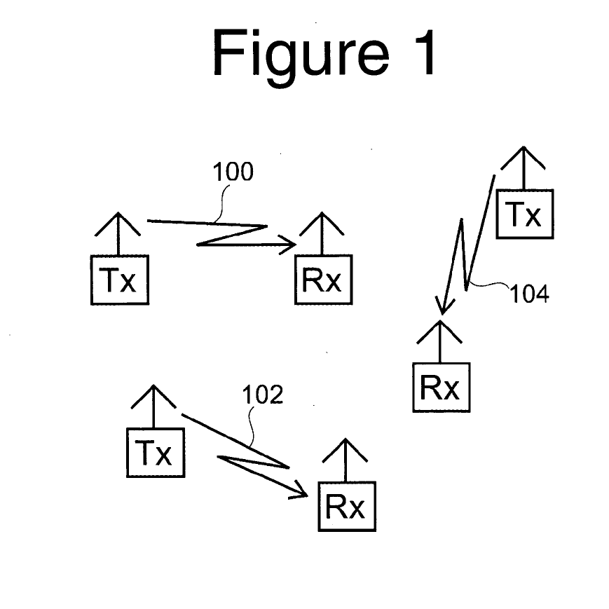

An example embodiment of the present invention and its potential advantages are understood by referring to FIGS. 1 through 9 of the drawings.

FIG. 1 shows radio links between wireless nodes in a radio environment. The nodes share the wireless medium, allowing any receiving node (Rx) to receive transmissions from any transmitting node (Tx). However, receiving signals from unintended transmitters may be undesirable. For example, transmissions from the transmitting node of first link 100 may be received by the antenna of the receiving node in second link 102 as undesirable interference. To reduce interference, access to the shared wireless medium may be structured into radio resources that can be individually assigned to wireless nodes for transmission and reception.

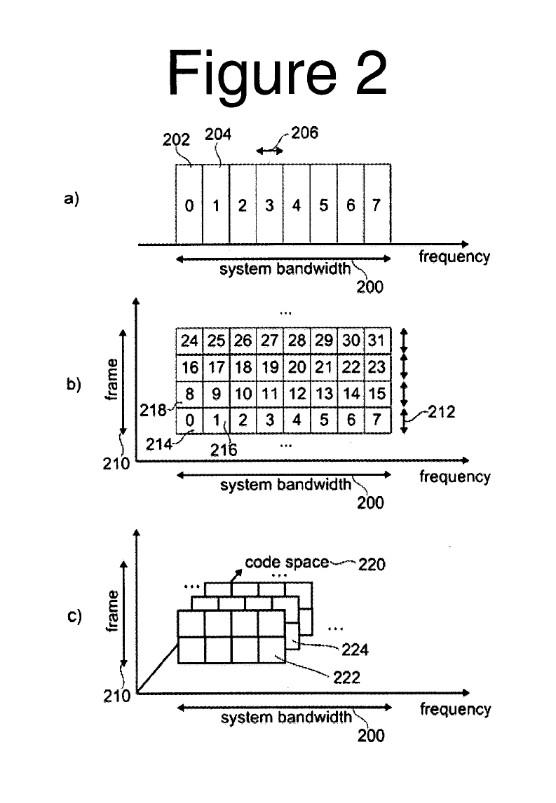

FIG. 2a shows a first example of structuring wireless medium into radio resources where system bandwidth is divided into eight radio resources, such as 202, 204, 206. Each radio resource occupies a non-overlapping frequency subband.

FIG. 2b shows another example of structuring wireless medium into radio resources. A periodic frame duration 210 that is known to radio nodes in a communication network is divided into four intervals, such as interval 212. Further, system bandwidth 200 is divided into eight non-overlapping frequency subbands. In this example, the combination of subband and time interval defines a non-overlapping radio resource. For example, radio resources 214 and 216 are non-overlapping in frequency, whereas radio resources 214 and 218 are non-overlapping in time.

Yet another example of structuring wireless medium into radio resources is shown in FIG. 2c, where access to the wireless medium is further structured using orthogonal codes in a code space 220. In this example, radio resources 222 and 224 occupy the same frequency subband and time interval in a frame, but use different sets of orthogonal codes that allow separation of the signals at a receiver. A transmission on one radio resource may cause only limited or no interference with another radio resource.

Interference between radio nodes may be avoided by assigning radio resources exclusively to transmitters in a neighborhood of wireless nodes. For example, to prevent interference between links in FIG. 1, first link 100 may be assigned first radio resource 202, and second link 102 may be assigned second radio resource 204.

For the exclusive assignment of radio resources in a neighborhood of nodes, a reservation protocol may be employed. When a radio resource is released by a reserving node and thus becomes available, a reservation protocol may resolve contention between several other nodes attempting to reserve the same radio resource. A reservation protocol may utilize an exponential backoff timer, forcing nodes to wait for increasing amounts of time between successive attempts to reserve a radio resource.

Delays in determining a “winner” node among nodes that are contending for radio resource may result in inefficiency. This is because such a delay leads to delay in radio transmissions and increased power consumption, which is especially critical in battery-powered devices.

Signaling between nodes may be performed by the transmission and detection of messages at a transmitter and a receiver node respectively. Messages may be transmitted by modulating a radio frequency carrier wave in amplitude and phase with a baseband representation of a message waveform.

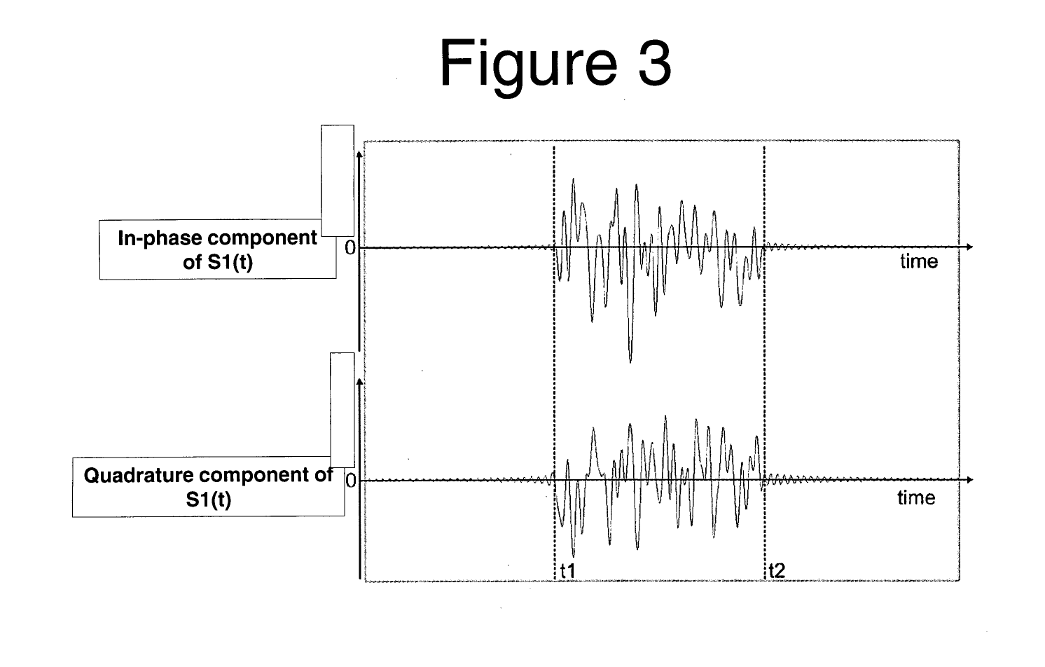

FIG. 3 shows an in-phase and a quadrature component of a message waveform S1(t). The waveform may tend to be limited in time, and the waveform may be transmitted within a time interval 212 defining a radio resource, as shown in FIG. 2b. Further, waveform S1(t) may utilize a limited set of orthogonal codes from a code space. By confining the message in time, frequency and/or code space, the message may be transmitted on a radio resource.

A plurality of waveforms S₁, S₂, S₃, . . . , Sₙ may be chosen to transmit a set of n messages. Two of the numerous criteria that may be used to choose waveforms S₁, . . . , Sₙ are suitable autocorrelation and crosscorrelation properties and low peak-to-average power ratio.

A detector may be used to determine the presence of a message Sₖ, where k=1, 2 . . . n, in a received signal. The detector may implement a sliding window correlator or a matched filter.

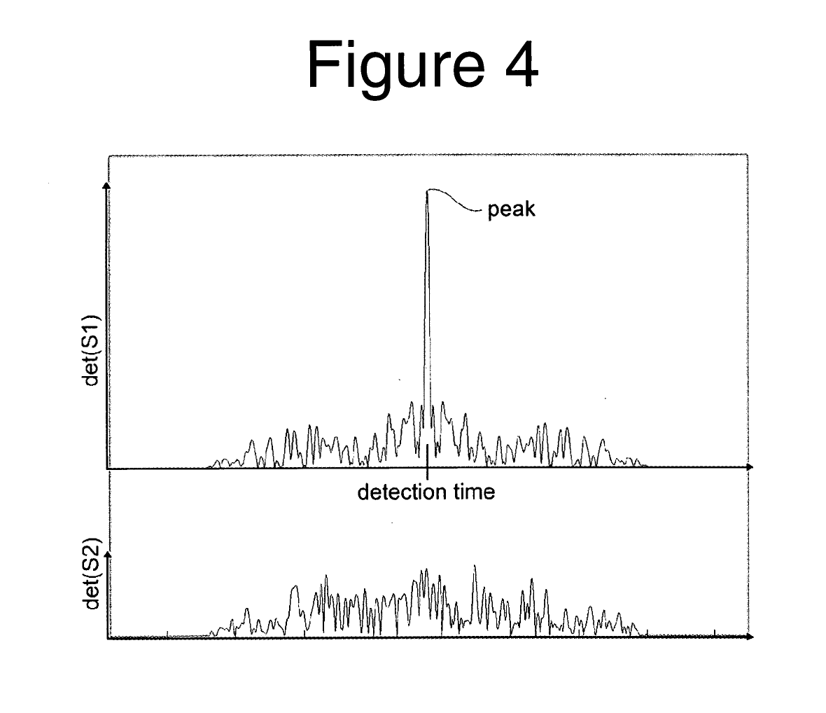

FIG. 4 shows output of a matched filter matched to signal S1(t), for two different input signals S1(t) and S2(t). The presence of message S₁ is indicated by a peak at a detection time as shown in FIG. 4. The peak may be detected by comparing the detector output against a first threshold. The first threshold may be predetermined.

If a large number of messages are received, the resulting high number of peaks may not be clearly distinguishable. In such a case, a better estimate of received messages may be obtained by applying an estimation function to the detector output. The estimation function may determine a time window, during which the detector output exceeds a second threshold. The estimation function may further determine a measure of energy of the detector output during the time window, quantize the measure of energy, index a lookup table using the quantized measure of energy and retrieve an estimation value for the number of received messages from the indexed lookup table.

The time instance of a peak at the detector output may be used to obtain a time reference. This time reference may be used by the detector to determine a time window.

Additionally, network load may be estimated by determining a measure of energy on the received signal in an unreserved radio resource. The measure of energy may be compared against one or more thresholds, and a network load indication may be set based on the outcome of the comparison.

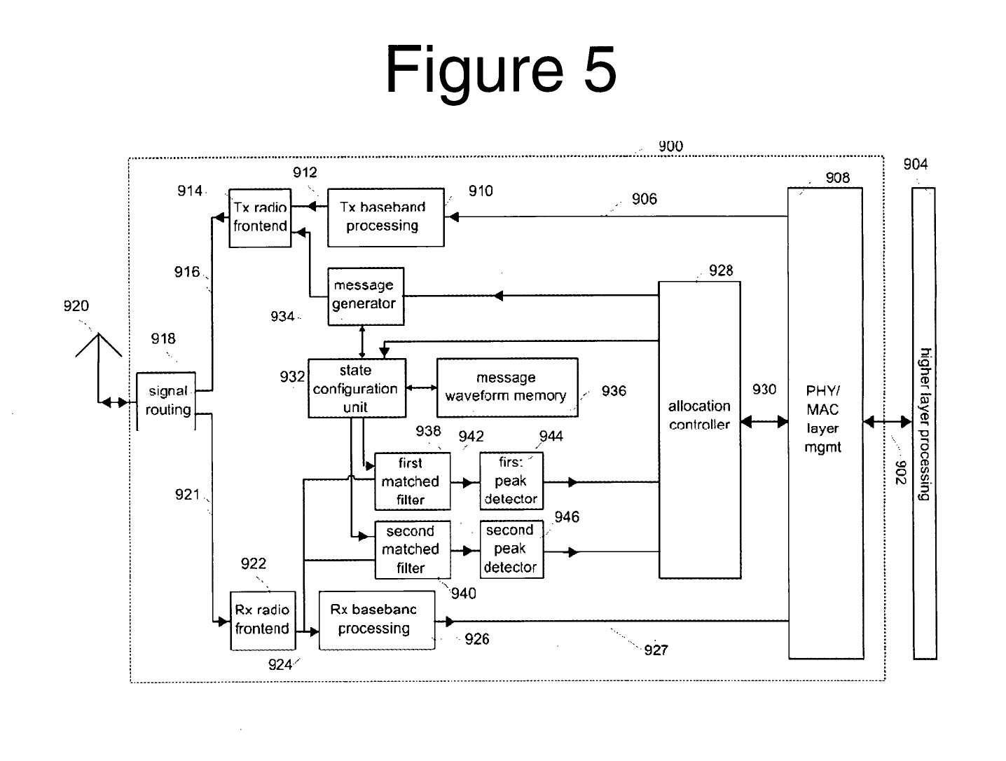

FIG. 5 shows an apparatus according to an embodiment of the invention. The apparatus 900 may be a radio transceiver. The radio transceiver may be part of a mobile wireless device.

Radio transceiver 900 exchanges transmit and receive data through a bus interface 902 for higher layer processing 904.

Transmit data received through bus interface 902 may be converted to a transmit stream 906 by a PHY/MAC layer management block 908. The PHY/MAC layer management block 908 may perform allocation of radio resources. The PHY/MAC layer management block 908 may also effect an assignment of transmit data to allocated radio resources by configuring transmit baseband processing block 910.

Transmit stream 906 may be provided to transmit baseband processing block 910. Transmit baseband processing block 910 generates a transmit baseband signal 912, based on transmit stream 906.

A baseband signal such as the transmit baseband signal 912 is a narrowband representation of a radio frequency signal at a center frequency lower than the carrier frequency of the radio frequency signal.

The transmit baseband signal 912 may be provided to the transmit radio front end 914. The transmit radio front end 914 converts the transmit baseband signal 912 into a transmit radio frequency signal 916 for transmission over wireless channel. Transmit radio frequency signal 916 is provided to signal routing block 918.

Signal routing block 918 feeds the transmit radio frequency signal to an antenna 920. Signal routing block 918 may use a circulator, a duplex filter, a diplex filter or semiconductor switches, for example to route the radio frequency signal 916 to the antenna 920.

Antenna 920 converts the transmit radio frequency signal to electromagnetic signal for transmission through the wireless medium. Further, antenna 920 also receives signals from the wireless medium and couples them to signal routing block 918.

Signal routing block 918 may route a received radio frequency signal 921 to receiver radio front end 922. Receiver radio front end 922 may convert the received radio frequency signal 921 to a received baseband signal 924 which is provided to the receiver baseband processing block 926.

Receiver baseband processing block 926 may convert the received baseband signal 924 into a received stream 927. PHY/MAC layer management block 908 may provide received stream 927 to higher layer processing.

According to an embodiment of the invention, PHY/MAC layer management 908 may decide to release unneeded radio resources. PHY/MAC layer management block 908 may send a control message to allocation controller 928 through allocation control interface 930.

Responding to the message, allocation controller 928 may signal state configuration unit 932 to initiate the release of resources.

State configuration unit 932 may configure message generator 934 to transmit a release message. An example of a release message is a M_REL message. The message M_REL may utilize a first waveform S0. The state configuration unit 932 may retrieve the first waveform S0 from a waveform memory 936. Message generator 934 may generate a baseband signal corresponding to the first waveform S0, that is then injected into the transmit path and ultimately transmitted via antenna 920.

The state configuration unit 932 may provide an identification of a radio resource to the message generator 934, effecting transmission of the message on one or more selected radio resources. Message generator 934 may apply a transformation operation to first waveform S0. The transformation operation may be a time shift operation, a frequency shift operation or a code modulation operation, for example. Instead of applying a transformation operation, message generator 934 may be provided a pre-transformed replica of waveform S0. The pre-transformed replica may be obtained from waveform memory 936.

Further, state configuration unit 932 may configure first matched filter 938 to a second waveform S1. Second waveform S1 may correspond to a application message. An example of an application message is a M_APP message. Further, state configuration unit 932 may configure second matched filter 940 to not detect any messages.

First matched filter 938 may apply a test statistic to received baseband signal 924. First matched filter 938 may perform a correlation operation between received baseband signal 924 and second waveform S1. First matched filter 938 may generate a first matched filter output signal 942 exhibiting peaks, for example as in FIG. 4. A peak in the first matched filter output signal 942 may correspond to a received second message M_APP in the received radio frequency signal 921. The reception of a message of type M_APP may indicate a request for acquisition of a radio resource.

First peak detector 944 may detect peaks in first matched filter output signal 942, for example by comparing a magnitude of first matched filter output signal against a threshold. The first peak detector 944 may report a detected peak to allocation controller 928. The allocation controller 928 may count the number of detected peaks in a time window. The time window may be chosen at a predetermined offset and duration relative to the transmission of the M_REL message.

Allocation controller 928 may determine that exactly one peak was detected during the time window. In this case, allocation controller 928 may signal state configuration unit 932 to initiate the transmission of an acknowledge message. An example of an acknowledgement message is a M_ACK message. State configuration unit 932 may configure message generator 934 to generate the waveform of a third message M_ACK from waveform memory 936. The waveform of third message M_ACK may be converted to radio frequency by transmit radio front end 914 and transmitted via antenna 920. The reception of the message M_ACK by another radio node may indicate a grant to the allocation of a radio resource to the another node.

Alternatively, allocation controller 928 may determine the detection of more than a predetermined number of peaks during the time window. In this case, allocation controller 928 may defer granting a request for radio resource acquisition. The predetermined number may be one.

Deferring the granting of the request by allocation controller 928 may be effected by not initiating the transmission of a M_ACK message.

If more than a predetermined number of M_APP messages is received during the time window, allocation controller 928 may determine a new time window and count the number of messages during the new time window. The number of messages during the new time window may be equal to the number of peaks in first matched filter output 942. The predetermined number may be one.

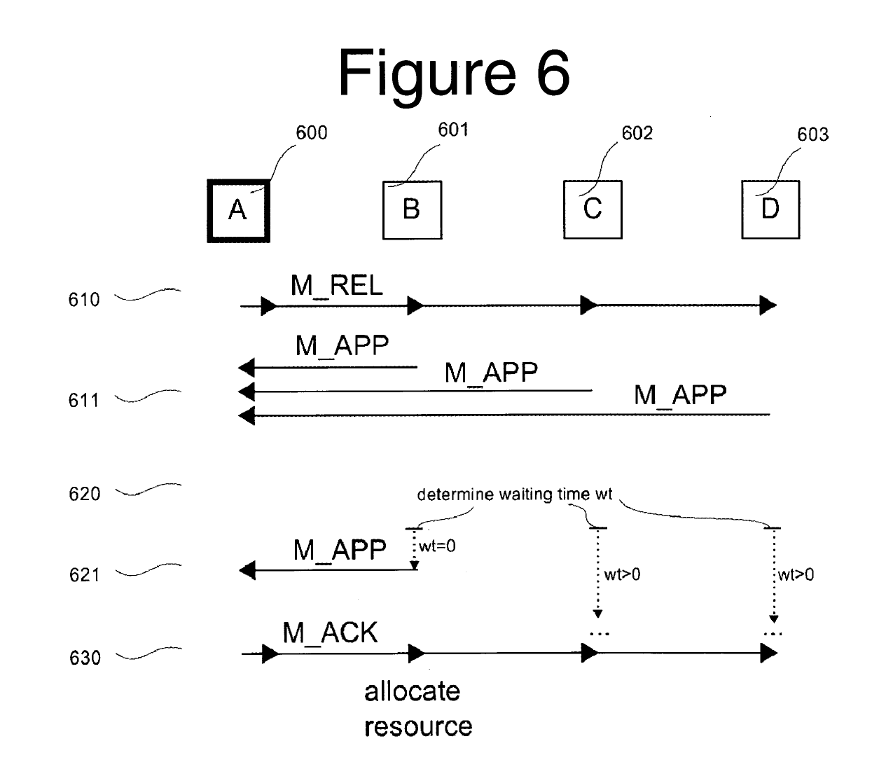

FIG. 6 shows signaling between network nodes in order to transfer radio resource according to an example embodiment of the invention. Each of the network nodes A, B, C, and D in FIG. 6 may be embodied as an apparatus, such as apparatus 900 of FIG. 5.

In time 610, node A 600 releases a radio resource by broadcasting a radio resource release message, for example a M_REL message. Several other nodes, for example nodes 601-603, monitoring the radio resource detect the M_REL message.

Each of the nodes 601-603 has need for the released radio resource and therefore, they request acquisition of the radio resource in time 611. In an example embodiment, nodes 601-603 transmit a radio resource acquisition message, for example an M_APP message, to node A 600.

Since node 600 detects the reception of multiple M_APP messages from several candidate nodes applying for the radio resource, it cannot decide on which node to allocate the released resource to, and thereby transmits no message at all in time 620.

In response to not receiving any message from node 600, nodes 601-603 determine a waiting time. Nodes 601-603 may use an exponential backoff algorithm to determine the waiting time. For example, the nodes pseudo randomly draw a number from an interval whose length is increased exponentially each time the algorithm is called, to determine the next transmission time of an M_APP message.

In time 621, based upon exponential backoff value picked by nodes 601-603, only one of the nodes, for example node 601, transmits an M_APP message.

Node 600 detects reception of a single M_APP message. In time 630, it transmits an M_ACK message, confirming transfer of the reservation to the node that sent the last APP message, in this example node 601.

Finally, node 601 takes the radio resource into use. Node 600 has thus handed over its reservation to a single node 601, and the process ends.

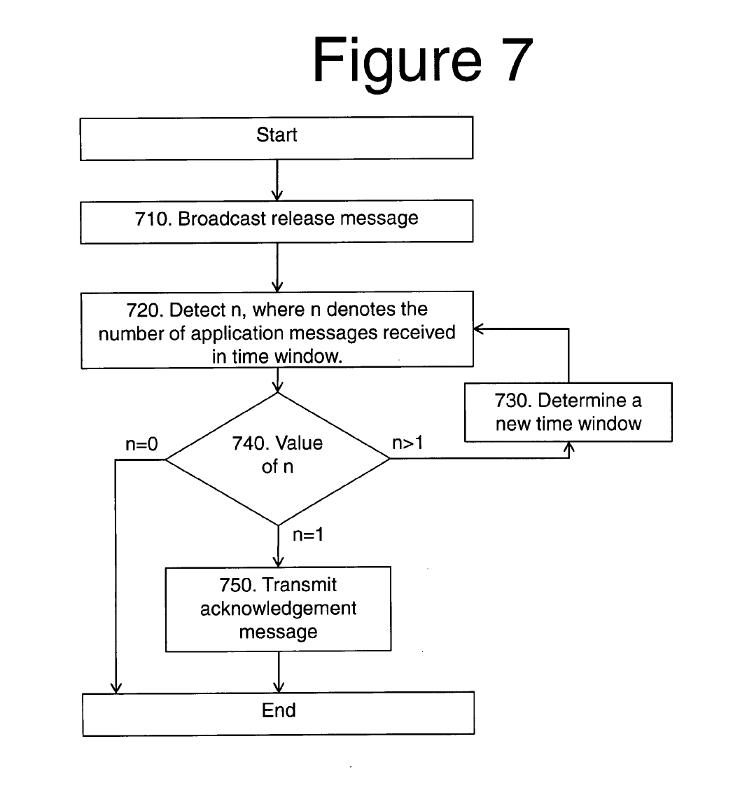

FIG. 7 shows a flowchart for operation of a node releasing radio resource according to an example embodiment of the invention. The flowchart of FIG. 7 may be executed by an apparatus, such as apparatus 900 of FIG. 5.

At block 710, a node releasing a past reservation broadcasts a release message, such as an M_REL message.

At block 720, the node detects the number, for example n, of received application messages, such as an M_APP message, requesting acquisition of the released resource during a predetermined window. If at block 740, the node determines that it has not received any requests for acquisition of released resource, denoted for example by n=0, the node transmits no further messages and the process ends.

If at block 740, the node determines that it has received exactly one application message during the predetermined time window, denoted by n=1, then at block 750 the node transmits an acknowledgement message, such as a M_ACK message.

The control of the released resource is now with the node that transmitted the received application message and the process terminates.

If at block 740, the node determines that it has received more than one application messages during the predetermined time window, denoted by n>1, then it transmits no messages and proceeds to block 730. At block 730, the node determines a new time window wherein to receive new requests for acquisition of resource. The process then returns to block 720.

In another example embodiment of the invention, if more than one request is received during a time window, allocation controller 928 (shown in FIG. 5) of a node releasing a past reservation may initiate the transmission of a message, for example a subgroup message, to defer granting the request for radio resource allocation and to reduce the set of nodes contending for radio resource to a smaller subset. An example of a subgroup message is an M_SUB message. Transmission of the M_SUB message may be performed by message generator 934, state configuration block 932 and message waveform memory 936 in a similar manner as already described for other types of messages. Message generator 934, state configuration block 932 and message waveform memory 936 are described in reference to FIG. 5.

The reception of the M_SUB message by another radio node may inform the radio node to not transmit any more M_APP messages and withdraw from contention for radio resource. The M_SUB message may also inform the other node to reset an exponential backoff process controlling the transmission of M_APP messages. Reception of the M_SUB message may instruct the other node to withdraw from contention, if the other node did not transmit an M_APP message in a time window relative to the reception time instant of the M_SUB message. Reception of the M_SUB message may instruct the other node to reset the exponential backoff process, if the other node did transmit an M_APP message in the time window. Thus, an M_SUB message received by several other nodes may select only part of the other nodes to continue competing for the radio resource, depending on whether or not each other node transmitted an M_APP message in the time window.

In yet another embodiment, upon receipt of multiple M_APP messages in the time window, allocation controller 928 may decide to transmit an M_SUB message, or to transmit no message at all. Allocation controller 928 may base the decision whether or not to transmit an M_SUB message on the number of M_APP messages received within a time window. The number of received M_APP messages may be counted by, for example, counting the number of peaks detected within a time window by the allocation controller 928 of FIG. 5.

Allocation controller 928 may also determine an estimate of number of nodes competing for radio resource by counting detected peaks over a longer time interval. Allocation controller 928 of FIG. 5 may decide to transmit an M_SUB message, if the estimated number of competing nodes in the environment exceeds a threshold, for example six.

Allocation controller 928 may also estimate congestion of the radio environment by determining a measure of power in the received signal. The determined measure of power may be determined in an unoccupied radio resource. Allocation controller 928 may decide to transmit an M_SUB message, if the determined measure of power exceeds a predetermined threshold.

In another example embodiment, allocation controller 928 may choose between a set of several messages of type M_SUB. For example, the messages M_SUB0, M_SUB1 and M_SUB2 may be defined.

Reception of a M_SUB0 message may instruct another node that had transmitted a M_APP message in a predetermined time interval prior to reception of the M_SUB0 message to initialize an exponential backoff process to state i=1, determine a random waiting time based on the exponential backoff process and retransmit an M_APP message after expiry of the random waiting time.

Reception of a M_SUB1 or M_SUB2 message may instruct the other node to proceed similarly to reception of a M_SUB0 message, but initialize the exponential backoff process to another predetermined state, for example i=2 for M_SUB1 and i=4 for M_SUB2.

Messages M_SUB0, M_SUB1, and M_SUB2 may be implemented by encoding i as a parameter into the message that assigns a new state to the exponential backoff process. In other words, the parameter may be used by the receiving node to determine a waiting period before transmitting another request. The scheme may be extended to an arbitrary number of M_SUB messages.

Reception of a M_SUB0 message, a M_SUB1 message or a M_SUB2 message by a node that has not transmitted an M_APP message in a predetermined time interval prior to reception of an M_SUB message may instruct the node to withdraw from contention for radio resource.

Allocation controller 928 may choose to transmit message M_SUB0, M_SUB1 or M_SUB2 based at least in part on one or more of the following: a count of number of peaks in a time window, an estimate of the number of simultaneous M_APP requests within the time window, an estimate of the number of competing nodes, an estimate of the congestion of the radio network, and/or the like. For example, allocation controller 928 may choose to transmit M_SUB0 if the number of simultaneous requests is below 4, M_SUB1 if the number of simultaneous requests is below 8, and M_SUB2 otherwise.

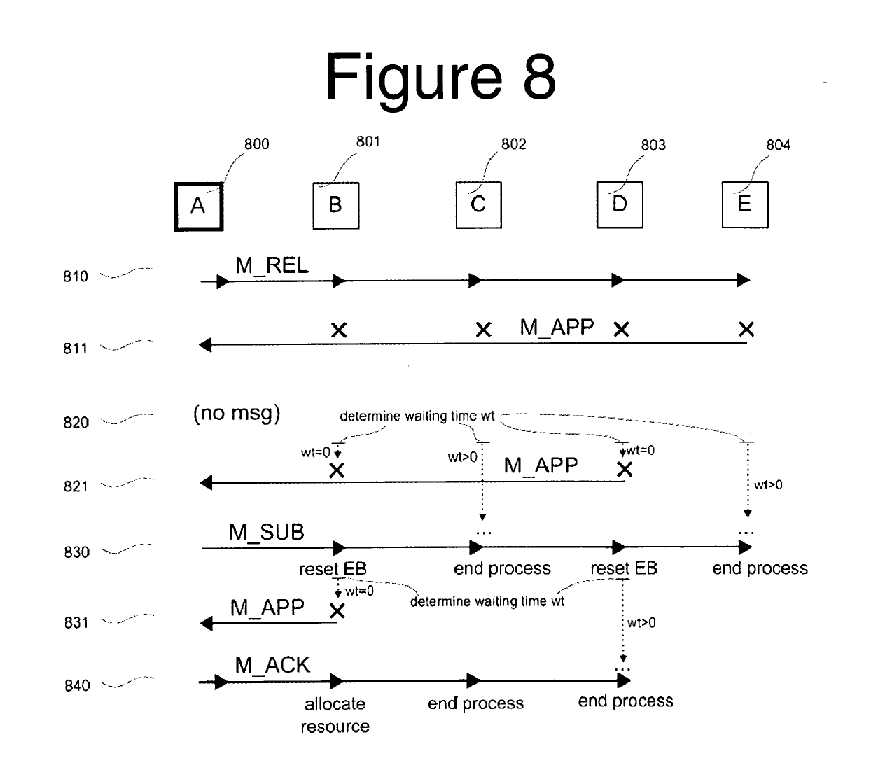

FIG. 8 shows signaling between network nodes in order to transfer radio resource according to another embodiment of the invention. Each of the network nodes A, B, C, D and E in FIG. 8 may be executed by an apparatus, such as apparatus 900 of FIG. 5.

In time 810, node A 800 releases a past reservation to a radio resource by broadcasting a radio resource release message, such as a M_REL message. Several other nodes 801-804 monitoring the radio resource detect the M_REL message.

In time 811, nodes 801-804 having need for radio resource request acquisition of the resource by transmitting an application message each. An example of an application message is a M_APP message.

In time 820, node 800 detects reception of multiple M_APP messages within a predetermined time interval. As a result, it does not transmit any message in response.

In time 821, all applying nodes 801-804 determine a pseudorandom exponential backoff delay that is either 0 or 1.

Node 801 and 803 draw a delay of 0 and re-send M_APP messages. Nodes 802 and 804 draw a delay of 1 and may not re-send M_APP message in this round.

In time 830, node 800 detects reception of multiple simultaneous M_APP messages and sends a M_SUB message.

In time 831, upon reception of the M_SUB message, the nodes that did not transmit M_APP during time 821 withdraw from contention of resource. Hence, only nodes 801 and 803 remain. Nodes 801 and 803 reset their exponential backoff processes and once again determine a waiting period. For example, nodes 801 and 803 may reset their exponential backoff processes to state i=1 and thus randomly draw a delay of either 0 or 1. Node 801 draws an exponential backoff delay of 0. Node 803 draws an exponential backoff delay of 1.

In time 840, node 801 draws an exponential backoff delay of 0, and re-sends its M_APP message. Node 803 draws an exponential backoff delay of greater than zero and does not transmit an M_APP message. Upon receiving exactly one M_APP message in a time interval, node A now assigns the resource to node 801 by transmitting an acknowledgement message, such as a M_ACK message.

According to yet another example embodiment of the invention and referring back to FIG. 5, PHY/MAC layer management 908 may decide to attempt to acquire additional radio resources. PHY/MAC layer management 908 may send a control message to allocation controller 928 through allocation control interface 930, and allocation controller 928 may signal state configuration unit 932 to initiate the acquisition of resources.

State configuration unit 932 may configure first matched filter 938 to the first waveform S0, corresponding to the message M_REL.

First matched filter 938 may detect the presence of an M_REL message in the received signal, and generate a peak in matched filter output signal 942 for a detected message. First peak detector 944 may detect the peak and generate a notification to allocation controller 928. The reception of an M_REL message may indicate the release of a radio resource by another node.

Triggered by the notification, allocation controller 928 may determine a waiting period. The determined waiting period may be 0. The waiting period may be determined based on an estimate of network load. For example, the waiting period may be set to zero, if the estimated network load is below a threshold, and to a randomly chosen value from the set {0, 1} otherwise. The duration of the waiting period is defined in units of a predetermined time interval.

The allocation controller 928 may initiate transmission of an application message such as a M_APP message after expiration of the determined waiting period relative to a time reference.

The time reference may be determined by allocation controller 928 based on the time instant of a detected peak from first peak detector 944. The time reference may comprise a predetermined time offset, allowing for processing delay, such as reconfiguration of signal routing block 918, for example.

Transmission of the message M_APP may be initiated by sending a signal from allocation controller 928 to state configuration block 932. The message M_APP may then be transmitted in a similar manner as was previously described for the transmission of other message types.

Allocation controller 928 may also use the time reference to configure a time window, during which detected peaks from first peak detector 944 or second peak detector 946 are treated as received messages. The combination of a matched filter, a peak detector and a time window, for example as implemented by first matched filter 938, first peak detector 944 and allocation controller 928 may be considered a detector for messages in a time interval relative to a time reference.

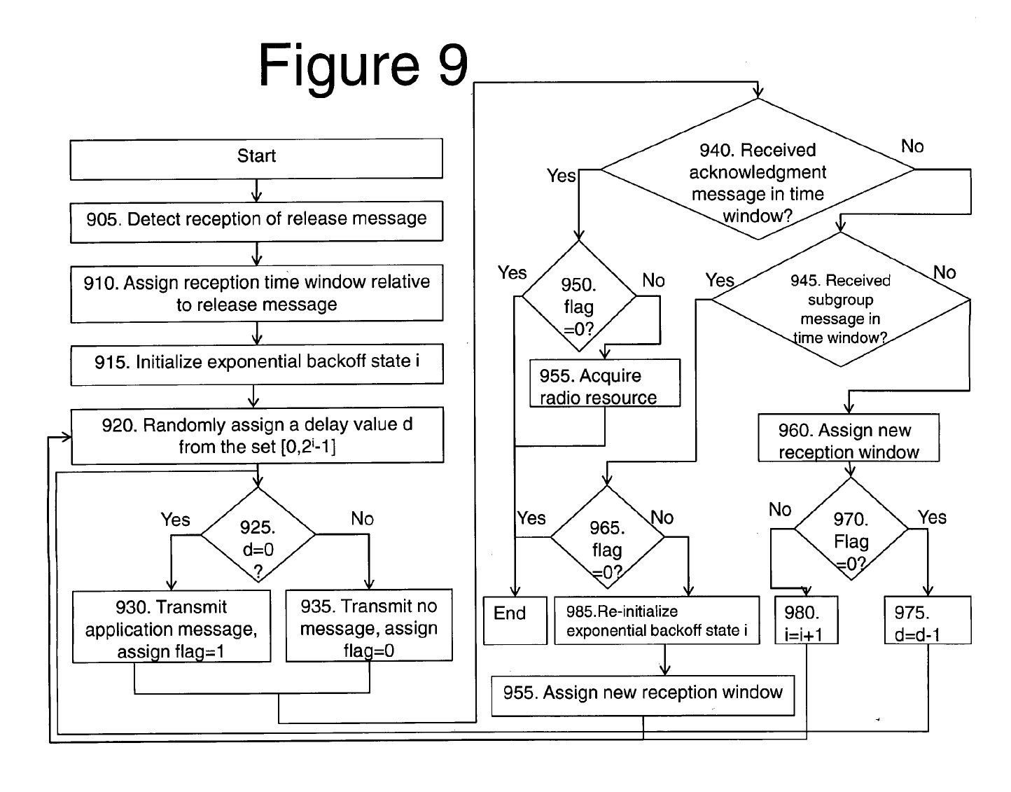

FIG. 9 shows a flowchart of a method implemented at a node competing for resource, for example node B, C, D, or E of FIG. 8, according to another example embodiment of the invention.

At block 905, a node desiring radio resource receives a release message, such as a M_REL message, indicating presence of a node releasing radio resource.

At block 910, the node desiring radio resource determines a time window relative to the time of reception of the release message, wherein to receive additional messages.

At block 915, the node desiring radio resource initializes an exponential backoff state, i. The node may initialize the exponential backoff state to a predetermined value i=0. The node may initialize the exponential backoff state based at least in part on an estimate of network load. The node may assign a lower initial value to the exponential backoff state if the estimated network load is low and a higher value if the estimated network load is high. The node may initialize the exponential backoff state based at least in part on a value signaled via a release message, of which M_REL message is an example. In one embodiment, a set of M_REL messages are defined, for example messages {M_REL0, M_REL1, M_REL2} that instruct the node desiring radio resource to initialize the exponential backoff state to a value identified by each message, for example {i=0, i=1, i=2} respectively.

At block 920, the node desiring radio resources assigns a random backoff delay d based on the exponential backoff state i. For example, for an exponential backoff state i, the delay may be randomly chosen between 0 and 2ⁱ−1. For example, if i=3, the delay may be randomly chosen between 0 and 7. For an exponential backoff state i=0, the delay may be always 0.

At block 925, the delay is compared to zero. If the delay equals zero, the node desiring the radio resource transmits an application message at block 930. An example of an application message is a M_APP message. Further, a flag is assigned a value of 1, indicating that the node has transmitted an M_APP message. The method then proceeds to block 940.

If the delay is not equal to zero, no M_APP message is transmitted. Further, the flag is assigned a value of 0 at block 935, indicating that the node has not transmitted an M_APP message. The method then proceeds to block 940.

At block 940, the node checks for the reception of an acknowledgement message, such as a M_ACK message, within the time window. If reception of an M_ACK message is detected, then at block 950, the node checks whether the flag is equal to 0. If the flag is equal to 0, then the node withdraws from contention and the process ends.

At block 950, if the flag is not equal to zero, then the node acquires radio resource at block 955. Thereafter, the process ends.

If at block 940, it is determined that the node did not receive an acknowledgement message within the time window, then at block 945 the node checks whether a subgroup message was received within the time window. An example of the subgroup message is a M_SUB message.

If at block 945, it is determined that a subgroup message was received within the time window, then at block 965 the value of the flag is checked. If the flag is equal to 0, the process terminates. However, at block 965 if the value of the flag is determined to be not equal to 0, the node enters block 985.

At block 985, the node re-initializes exponential backoff state i. In an example embodiment, the value of i is initialized to 1. In another embodiment, the value assigned to i is extracted from the subgroup message. In yet another embodiment, a set of subgroup messages is defined, for example messages {M_SUB0, M_SUB1, M_SUB2} that instruct the node contending for radio resource to initialize the exponential backoff state i to a value predetermined for each message, for example {i=0, i=1, i=3} respectively.

At block 955, a new reception time window is assigned and thereafter, control of the process is transferred to block 920.

If at block 945, it is determined that no subgroup message was received within the time window, then at block 960 a new reception window is assigned. The process then enters block 970.

At block 970, the node checks the value of the flag. If the value of the flag is equal to 0, then at block 975 the waiting period is re-determined by decrementing the delay by 1 and the control is shifted to block 925.

If at block 970, it is determined that the flag is not equal to zero, then at block 980 the exponential backoff state i is incremented by 1 and the process continues at block 920.

Without in any way limiting the scope, interpretation, or application of the claims appearing below, a technical effect of one or more of the example embodiments disclosed herein is allocation of radio resource among network nodes. Another technical effect of one or more of the example embodiments disclosed herein is efficient allocation of radio resources.

Embodiments of the present invention may be implemented in software, hardware, application logic or a combination of software, hardware and application logic. The software, application logic and/or hardware may reside on an access point, a client node, or another network node. If desired, part of the software, application logic and/or hardware may reside on access point, part of the software, application logic and/or hardware may reside on client node, and part of the software, application logic and/or hardware may reside on another network node. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-45. (canceled)

46. An apparatus, comprising:
a transmitter configured to transmit a message releasing radio resource;
a receiver configured to receive one or more requests for acquisition of at least part of the released radio resource; and
a controller configured to defer grant of any request for radio resource acquisition if more than a predetermined number of requests is received within a predetermined time window.

47. The apparatus of claim 46, wherein the message releasing radio resource contains information for determining a waiting period.

48. The apparatus of claim 46, wherein the controller is further configured to determine a new time window for receiving requests for acquisition of radio resource if more than the predetermined number of requests is received within the predetermined time window.

49. The apparatus of 46, wherein the transmitter is further configured to transmit a message informing at least one network node to not transmit any more requests for acquisition of radio resource if more than the predetermined number of requests for acquisition of radio resource is received in the predetermined time window.

50. The apparatus of claim 49, wherein the message informing the at least one network node to not transmit any more requests is based at least in part on at least one of:
an estimate of number of simultaneously received requests for allocation of the released radio resource,
an estimate of number of nodes competing for the released radio resource, and
an estimate of congestion of radio environment, and wherein the message contains a parameter to be used by at least one receiving node to determine a waiting period before transmitting another request.

51. An apparatus, comprising:
a receiver configured to receive a message releasing radio resource;
a controller configured to determine at least one waiting period, wherein the waiting period may be zero; and
a transmitter configured to transmit a first request for acquisition of the released radio resource upon expiry of the waiting period.

52. The apparatus of claim 6, wherein a state of an exponential backoff timer is configured based at least in part on information contained in the message releasing radio resource.

53. The apparatus of claim 51, wherein:
the controller is further configured to derive a timing reference using the time at which the message releasing radio resource was received; and
the transmitter is further configured to transmit messages based at least in part on the timing reference.

54. The apparatus of claim 51, wherein the determination of the at least one waiting period is based at least in part on an estimate of network load.

55. The apparatus of claim 51, wherein:
the controller is further configured to redetermine the waiting period; and
the transmitter is further configured to retransmit a request for
acquisition of the released radio resource if the another waiting period is zero.

56. The apparatus of claim 51, wherein
the receiver is further configured to receive a message requesting withdrawal from contention for released radio resource; and
the controller is further configured to withdraw from contention for released radio resource if a request for acquisition of the released radio resource has not been transmitted in a predetermined time period.

57. An apparatus of claim 51, wherein:
the receiver is further configured to receive a message allocating released radio resource;
the controller is further configured to determine whether a request for acquisition of released radio resource was transmitted in a predetermined time period prior to the reception of the message;
if the request was transmitted in the predetermined time period, the controller further configured to acquire the released radio resource; and
if the request was not transmitted in the predetermined time period, the controller further configured to withdraw from contention for the released radio resource.

58. A method, comprising:
releasing a radio resource by a network node;
starting a time window wherein to receive one or more requests for acquisition of at least part of the released radio resource; and
deferring grant of any request for acquisition if more than a predetermined number of requests is received within the time window.

59. The method of claim 58, further comprising transmitting a message by the network node indicating released radio resource, wherein the message contains a parameter to be used by at least one receiving node to determine a waiting period before transmitting a new request, wherein the message releasing radio resource contains information that can be used for determining a waiting period.

60. The method of claim 58, further comprising receiving more than a predetermined number of requests within the time window and initiating another time window wherein to receive new requests.

61. The method of claim 58, further comprising
receiving more than a predetermined number of requests within the time window;
transmitting a message informing at least one network node to not transmit any more requests; and
initiating another time window wherein to receive new requests,
wherein the message is based at least in part on at least one of
an estimate of number of received requests for acquisition of the released radio resource,
an estimate of number of nodes competing for the released radio resource, and
an estimate of congestion of radio environment.

62. A method, comprising:
receiving a message releasing radio resource;
determining at least one waiting period which may be zero; and
transmitting a request for acquisition of the released radio resource upon expiry of the waiting period.

63. The method of claim 62, further comprising
deriving a timing reference using the time at which the message releasing radio resource was received; and
using the timing reference for transmission or detection of messages.

64. The method of claim 62, further comprising
determining a new waiting period which may be zero; and
transmitting a new request for acquisition of the released radio
resource after expiry of the waiting period unless a message requesting withdrawal from contention for released radio resource is received before expiry of the new waiting period.

65. The method of claim 62, further comprising
receiving a message requesting withdrawal from contention for released radio resource; and
withdrawing from contention for released radio resource unless a request for acquisition of released radio resource was transmitted during a predetermined time window prior to the reception of the message requesting withdrawal from contention for released radio resource.

66. A method, comprising:
receiving a message allocating radio resource;
determining whether a request for acquisition of radio resource was transmitted in a predetermined time period prior to the reception of the message allocating released radio resource;
if the request was transmitted, acquiring the released radio resource; and
if the request was not transmitted, withdrawing from contention for the released radio resource.

67. A computer-readable medium encoded with instructions that, when executed by a computer, perform:
receiving a message releasing radio resource;
determining at least one waiting period which may be zero; and
transmitting a request for acquisition of the released radio resource upon expiry of the waiting period.
